(19) United States
(12) Patent Application Publication
(10) Pub. No.: US 2017/0057276 A1
(43) Pub. Date: Mar. 2, 2017

(54) PANEL WITH RUSTIC CHAMFER AND METHOD FOR PRODUCING SAID PANEL

(71) Applicant: Kaindl Flooring GmbH, Wals (AT)

(72) Inventors: Gerhard Dürnberger, Strasswalchen (AT); Andreas Wallinger, Abtenau (AT); Rupert Krallinger, St. Martin (AT)

(21) Appl. No.: 15/307,659

(22) PCT Filed: May 6, 2015
(86) PCT No.: PCT/EP2015/059927

§ 371 Date: Oct. 28, 2016

(30) Foreign Application Priority Data
May 9, 2014 (DE) 10 2014 208 742.2

(51) Int. Cl. B44C 1/22; B23C 3/12

(52) U.S. Cl. CPC B44C 1/22; B23C 3/12; B23C 2220/16

(57) ABSTRACT

A panel for cladding a substrate and a method for producing same, in which a plurality of indentations, which start from the visible surface, extend so as to be inclined (α, β) relative to the visible surface and end in respective side surface, are formed at the transition from the visible surface into at least one of the side surfaces to form a chamfer. A The chamfer is formed solely by the plurality of indentations, which include at least a first group of indentations all of which extend in an inclined manner relative to the visible surface at a first inclination angle (α), and a second group of indentations all of which extend in an inclined manner relative to the visible surface at a second inclination angle (β), the first inclination angle (α) and the second inclination angle (β) different from each other.

### BACKGROUND

The invention relates to a panel for cladding a substrate, comprising a visible surface, which is delimited by a plurality of side edges, a contact surface, which extends substantially in parallel with the visible surface and is intended to contact the substrate when laid, and a plurality of side surfaces, which extend substantially orthogonally to the visible surface and the contact surface, a plurality of indentations, which start from the visible surface, extend so as to be inclined relative to the visible surface and end in one of the side surfaces, being formed at the transition from the visible surface into at least one of the side surfaces to form a chamfer.

### BRIEF DESCRIPTION

The generic patent CN 103 233 568 A discloses panels in which a plurality of separate indentations are made in a planar sloping surface which connects the visible surface to the side surface and extends over the entire length of the side surface.

WO 2006/066776 A2 discloses a panel of which the entire visible surface up to the side edges thereof is three-dimensionally structured by means of complex machining.

In addition, EP 1 898 024 A1 discloses panels in which a chamfer is formed at the transition from the visible surface into at least one of the side surfaces and comprises two portions which extend over the entire length of the side surface. A first portion is directly adjacent to the side surface and is planar, while the second portion, which is arranged between the first portion and the visible surface, is undulating.

Against the background of this prior art, the problem addressed by the present invention is to provide panels which have an improved rustic appearance and which can be produced in a simple manner.

The problem is solved according to the invention by a panel of the type in question, in which the chamfer is formed solely by the plurality of indentations, the indentations including at least a first group of indentations and a second group of indentations, the indentations in the first group all extending in an inclined manner relative to the visible surface at a first inclination angle, and the indentations in the second group all extending in an inclined manner relative to the visible surface at a second inclination angle, and the first inclination angle and the second inclination angle being different from each other.

Two effects are achieved by the chamfer being formed solely by the plurality of indentations. On one hand, production is simplified, since the step, which precedes the indentations being made, of manufacturing a planar sloping surface which extends over the entire length of the side surface in question is omitted, and on the other hand, a more realistic rustic appearance of the panels is produced owing to the omission of the planar sloping surface.

The at least two groups of indentations may for example be made in the panels by two material-removing tools being used, the cutting edges of which cut into the panel at differing inclination angles at the transition from the visible surface into the respective side surfaces. This can be achieved in a simple manner by the axes of the two material-removing tools extending at differing inclination angles relative to the panel, while the cutting edges of the two material-removing tools extend in parallel relative to the axis of the associated tool. It is however also conceivable for the cutting edge of at least one tool to extend in an inclined manner relative to the axis of said tool. In this case, the axes of the two material-removing tools may also extend in parallel. Furthermore, the material-removing tools may be arranged such that the contour of the shaft of the tool is arranged entirely outside the contour of the panel which is moved past said tool and only the cutting edge projecting from the shaft is arranged at least in part within the contour of the panel which is moved past the tool.

The inclination angle of the one group of indentations may be between approximately 3° and approximately 35°, preferably approximately 12°, while the inclination angle of the other group of indentations may be between approximately 5° and approximately 50°, preferably approximately 23°, it being possible for the difference between the two inclination angles to be between approximately 2° and approximately 47°, preferably between approximately 5° and approximately 20°.

At least one of the material-removing tools may be a milling cutter. Preferably, all the material-removing tools are milling cutters. The milling cutter used to produce the first group of indentations may have a diameter of approximately 10 mm and may be operated at a rotational speed of approximately 10,000 rpm, while the milling cutter used to produce the second group of indentations may have a diameter of approximately 10 mm and may be operated at a rotational speed of approximately 8,500 rpm.

The feed rate of the panels may be between approximately 100 m/min and approximately 120 m/min, preferably approximately 108 m/min. In addition, the feed direction of the panels may be counter to the movement direction of the circumferential portion of the material-removing tool which is cutting into the panel in each case.

To make production easier, in a development of the invention it is proposed that the indentations in the first group be made in the panel at a substantially constant first period length, that the indentations in the second group be made in the panel at a substantially constant second period length and that the first period length and the second period length be different from each other. Preferably, one period length is also not an integral multiple of the other period length. If the length, measured in the direction of longitudinal extension of the side surface, of the indentations in one group is less than the period length of this group, then consecutive indentations in this group are arranged so as to be spaced apart.

In terms of production, this can be achieved for example by the panel being moved past the material-removing tools at a substantially constant feed rate, while the material-removing tools rotate at substantially constant but differing rotational speeds about their axes.

In principle, however, it is also conceivable for the period length of the first group of indentations and/or the period length of the second group of indentations to vary between pairs of indentations. This further increases the variability of the arrangement of the indentations and thus also increases the realistic feel of the rustic appearance.

In terms of production, this can be achieved for example by the panel being moved past the material-removing tools at a substantially constant feed rate, while the material-removing tools rotate at varying rotational speeds about their axes. A further effect which is achieved by varying the rotational speeds of the material-removing tools is the associated variation in the shape of the indentations. If the rotational speed of a tool is increased, then the shape of the indentation is compressed in the longitudinal direction of the side surface in question, since, after cutting into the panel, the cutting edge of the tool comes out of engagement with said panel again more quickly. Accordingly, the shape of the indentation is stretched at a lower rotational speed. This effect also contributes to further increasing the variability of the arrangement of the indentations and thus also the realistic feel of the rustic appearance.

The realistic feel of the rustic appearance of the panels can be increased yet further by the indentations being arranged so as to overlap with one another over greater than 95%, preferably over greater than 98%, more preferably over substantially 100%, of the longitudinal extension of the side surface. As a result, regions in which the visible surface and the side surface meet in a substantially orthogonal manner and thus impair the rustic appearance can be largely, if not completely, avoided.

In terms of production, this can be achieved for example by one of the material-removing tools comprising at least two cutting edges, the feed rate of the panel, the rotational speed of the material-removing tool, the relative movement direction of the material-removing tool and of the panel in their region of mutual engagement and the cutting-in depth of the cutting edges into the panel being coordinated with one another such that the indentations are arranged so as to overlap with one another over greater than 95%, preferably over greater than 98%, more preferably over substantially 100%, of the longitudinal extension of the side surface.

If the cutting edges of the material-removing tool in question are formed so as to be identical, then all the indentations formed by this tool are the same shape and can thus be considered to belong to the same group of indentations. By coordinating the feed rate of the panel, the rotational speed of the tool, the relative movement direction of the tool and the panel in their region of mutual engagement (the panel and the cutting edge of the tool may move both in the same and in opposite directions relative to each other in their region of engagement) and the cutting-in depth of the cutting edges into the panel, as previously mentioned, the indentations can be formed so as to be directly consecutive, so that their respective lengths are simultaneously equal to their period of succession. It is even possible for them to overlap. In both cases, the distance between consecutive indentations is equal to zero.

In principle, however, it is also conceivable for the cutting edges of the material-removing tool in question to be formed so as to be different from one another. In this case, the indentations formed by the additional cutting edges form at least one additional group of indentations. Nevertheless, by coordinating the feed rate of the panel, the rotational speed of the tool, the relative movement direction of the tool and the panel and the cutting-in depth of the cutting edges into the panel, the indentations may also overlap or be directly consecutive in this case, so that indentations are provided over the entire longitudinal extension of the side surface.

In a development of the invention, it may be provided that the indentations in one of the groups of indentations are deeper than the indentations in the other group of indentations. In terms of production, this can be achieved for example by the at least one cutting edge of the tool which is assigned to the one group of indentations cutting deeper into the panel than the at least one cutting edge of the tool which is assigned to the other group of indentations. For example, the at least one cutting edge of the tool assigned to the one group of indentations may cut into the panel by a depth of approximately 0.8 mm, while the at least one cutting edge of the tool assigned to the other group of indentations only cuts into the panel by a depth of approximately 0.6 mm.

This is particularly advantageous if the tool which is used to produce the one group of indentations is formed so as to have at least two cutting edges in order to form a succession of indentations which is preferably completely free of spacing. By the cutting edge(s) of the tool which is used to produce the other group of indentations cutting in more deeply, the indentations in the one group remain still visible practically only in the gaps between the indentations in the other group. If the other group of indentations also has a period length which differs from that of the one group of indentations, then the appearance which remains from the indentations in the one group varies. Overall, a very realistic rustic appearance of the chamfer, which is formed solely by indentations, is thus produced.

Another option for making the rustic appearance of the panel more realistic consists in that the first group of indentations and/or the second group of indentations is formed so as to have a variable maximum depth. For this purpose, the distance between the material-removing tools, which are used to produce the first group of indentations and/or the second group of indentations, and the panel may be varied during processing. In principle, however, said tools can also be operated with a constant distance therebetween.

In order to prevent the material which is removed from the panels during formation of the indentations from impeding the further processing of the panels, it is proposed that, when the indentations are being made, the panels be processed in a material-removing manner with the visible surface facing downwards.

In a development of the invention, it is proposed that, after the indentations are made, the panel be printed. As a result, it can be ensured in a simple manner that the printed image realistically also extends continuously into the indentations. If it is necessary to prime the panel before printing in order to improve its printability, this priming advantageously likewise only takes place after the indentations are made, in order to improve the printability of the indentations as well.

The printing can be carried out for example by means of a digital printing process, preferably by means of an inkjet printing process, as is known per se from the prior art.

The panels may be made of an MDF (medium density fibreboard) board and/or an HDF (high density fibreboard) board and/or an OSB (oriented strand board) board and/or a chip board and/or a plywood board and/or a multilayer board. Advantageously, the surfaces of these boards can be printed directly, it being possible for said boards to have been primed first if necessary, as described above. It is however also possible to provide the surface of said board which forms the visible surface with a printable layer and/or to provide the surface which forms the contact surface with a counteracting layer. The printable layer may for example be a laminate including at least one paper layer and/or a veneer and/or a layer including cork and/or at least one textile and/or at least one plastics material and/or at least one mineral. The layer may however also be made of linoleum and/or natural rubber and/or rubber. The counteracting layer may also be formed as a single- or multi-layer, synthetic-resin-impregnated paper layer and/or as a layer including a veneer and/or cork and/or at least one textile and/or at least one plastics material and/or at least one mineral and/or made of linoleum and/or natural rubber and/or rubber.

After printing, the panel can be provided with a protective layer in a manner known per se. This protective layer is preferably transparent so as to allow the printed decorative design to show through, but still protects the visible surface from wear due to the panels, which are used as floor panels, being walked on, for example. The materials or material compositions that are known from the prior art can be used to form the protective layer.

As is known per se, a connection element can be provided on the panel according to the invention on at least one side surface, preferably on at least one pair of opposing side surfaces, more preferably on all side surfaces, which connection element is designed and intended to be connected to another identically formed panel. The connection elements may preferably be formed integrally with the panel. Preferably, the connection elements may be tongue-and-groove-type connection elements.

It should be added that the chamfer formed according to the invention may not just be formed on one of the side surfaces of the panels. Rather, it is also possible for chamfers formed according to the invention to be provided on at least one pair of opposing side surfaces, preferably at least on the side surfaces forming the two longitudinal sides of the panels. Lastly, it is also conceivable for chamfers formed according to the invention to be provided on all side surfaces of the panel.

It should also be added that the substrate may for example be a floor and/or a wall and/or a ceiling. The panel may thus be a floor panel and/or a wall-cladding panel and/or a ceiling-cladding panel.

The invention also relates to a method for producing a panel provided with a chamfer formed according to the invention. Reference is made to the above discussion with regard to the details of this method, to the options for developing said method and to the advantages which can be achieved thereby.

The invention is described in greater detail in the following on the basis of an embodiment with reference to the accompanying drawings, in which:

### BRIEF DESCRIPTION OF THE DRAWINGS

FIG. 1 is a schematic perspective view for explaining the structure of a device for producing panels according to the invention and for carrying out the method according to the invention;

FIG. 2 is a schematic perspective view of three panels for explaining the manufacture of the chamfer according to the invention; and

FIG. 3 is a further schematic diagram for explaining the manufacture of the chamfer according to the invention.

### DETAILED DESCRIPTION

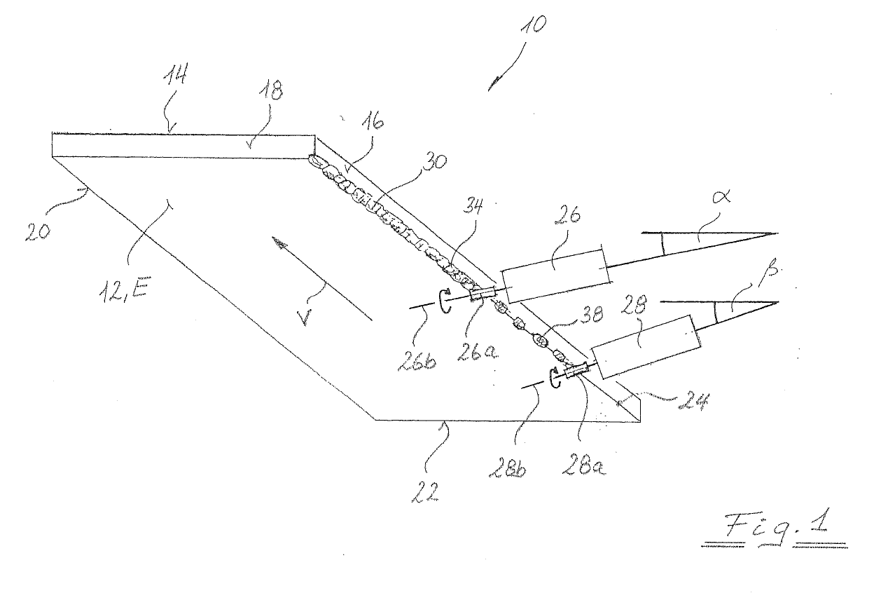

In FIG. 1, a panel according to the invention which is intended for cladding a substrate, for example a floor, is in general provided with reference numeral 10. Said panel has a visible surface 12, which is the lower surface in FIG. 1 because the panel 10 is processed in an inverted orientation. The panel 10 also has a contact surface 14, intended to come into indirect or direct contact with the substrate, and four side surfaces 16, 18, 20 and 22.

FIG. 1 shows how the longitudinal edge 24 which connects the visible surface 12 to the side surface 16 is processed by means of two milling units 26 and 28 to form the chamfer 30 according to the invention, while the panel 10 is moved in the feed direction V past said milling units. The milling tools 26a and 28a of the milling units 26 and 28 are driven in a rotary manner such that the circumferential portion thereof which is in milling engagement with the panel 10 is moved in the opposite direction to the feed direction of the panel 10.

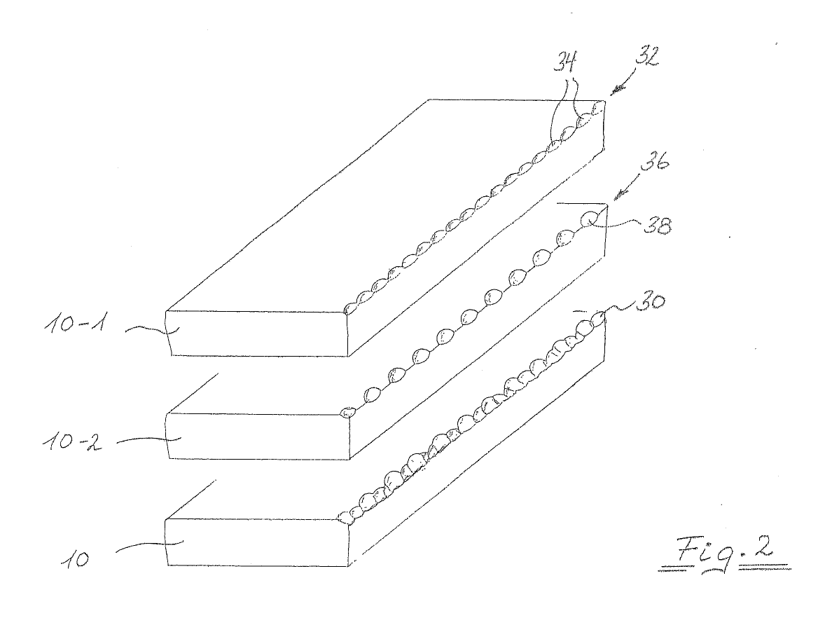

The milling tool 26a of the first milling unit 26 has two identically formed cutting edges, which form a first group 32 of indentations 34 (see FIG. 2). In this case, the indentations 34 are linked to one another or overlap, such that the longitudinal edge 24 which is formed by the orthogonally adjoining surfaces 12 and 16 no longer exists at any point on the finished panel 10. By contrast, the milling tool 28a of the second milling unit 28 has just one single cutting edge which forms a second group 36 of indentations 38 (see FIG. 2). The indentations 38 are arranged so as to be spaced apart.

The cutting edges of the milling tool 26a extend substantially in parallel with the rotational axis 26b and cut into the panel 10 by a depth of approximately 0.6 mm, measured from the longitudinal edge 24. Furthermore, the rotational axis 26b and the plane E formed by the visible surface 12 enclose an angle α which is approximately 23° in the embodiment shown. The cutting edge of the milling tool 28a extends substantially in parallel with the rotational axis 28b and cuts into the panel 10 by a depth of approximately 0.8 mm, measured from the longitudinal edge 24. Furthermore, the rotational axis 28b and the plane E enclose an angle β which is approximately 12° in the embodiment shown.

For the sake of better understanding, at the top of FIG. 2 a panel 10-1 is shown in which only the indentations 34 of the first group 32 of indentations have been made by means of the milling tool 26a of the first milling unit 26, and below this a panel 10-2 is shown in which only the indentations 38 of the first group 36 of indentations have been made by means of the milling tool 28a of the first milling unit 28. Finally, at the very bottom of FIG. 2, the finished panel 10 from FIG. 1 is shown.

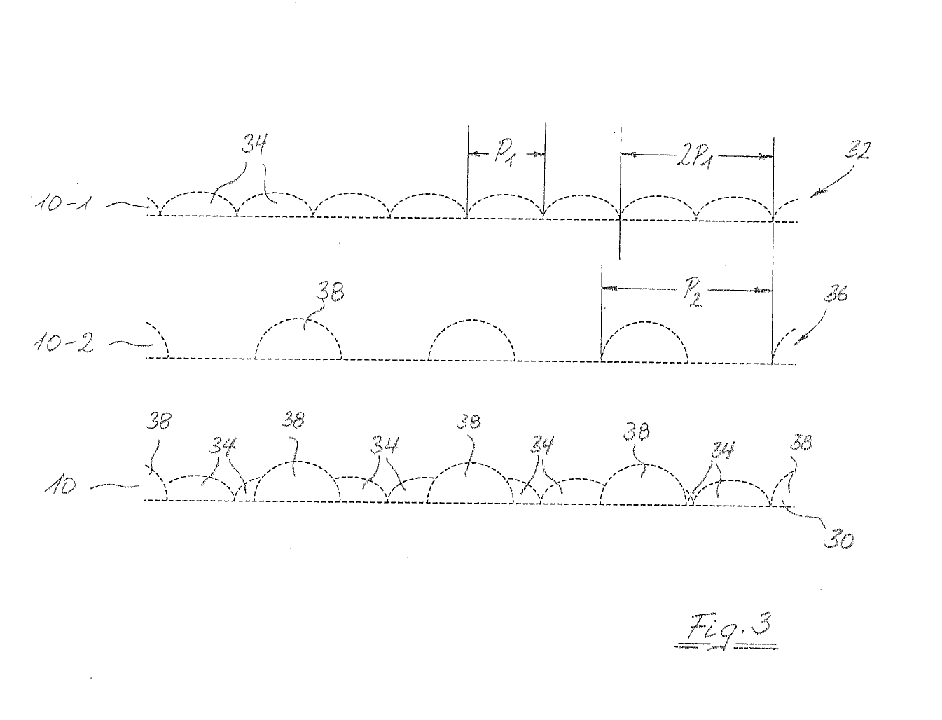

FIG. 3 again schematically shows the indentations 34 and 38 in a plan view of the visible surface 12, in order to explain how a chamfer 30 having a realistic rustic look is formed by the two milling units 26 and 28 cooperating.

As already explained, the indentations 34 are arranged at a first period length P1, while the indentations 38 are arranged at a second period length P2. Not only are the two period lengths P1 and P2 different from each other (P1≠P2), but the period length P2 is also different from double the period length P1 (P2 ≠2·P1). If the two milling tools 26a and 28a were rotated at the same rotational speed, the period length P2 would be equal to twice the period length P1 (P2=2·P1), since the milling tool 26a has two cutting edges while the milling tool 28a only has a single cutting edge. Therefore, the milling tool 26 can be rotated at a rotational speed, for example approximately 10,000 rpm, which differs from that of the milling tool 28a, for example approximately 8,500 rpm.

When the indentations 34 and 38 are overlaid, the indentations 34 only remain visible in the gaps between the indentations 38, owing to the cutting edge of the milling tool 28a cutting in deeper. In addition, owing to the differing period lengths P1 and P2, a cut-out, which is always different, from the indentation pattern formed by the indentations 34 is produced between the indentations 38. This increases the effect produced by the differing set angles of the milling tools 26a, 28a and, together with this effect, leads to an irregular and thus realistic rustic appearance of the chamfer 30.

1. Panel for cladding a substrate, comprising:
a visible surface, which is delimited by a plurality of side edges,
a contact surface, which extends substantially in parallel with the visible surface and is intended to contact the substrate when laid, and
a plurality of side surfaces, which extend substantially orthogonally to the visible surface and the contact surface, a plurality of indentations, which start from the visible surface, extend so as to be inclined relative to the visible surface and end in the respective side surface, being formed at the transition from the visible surface into at least one of the side surfaces to form a chamfer,
wherein the chamfer is formed solely by the plurality of indentations,
the indentations including at least a first group of indentations and a second group of indentations,
the indentations in the first group all extending in an inclined manner relative to the visible surface at a first inclination angle (α), and the indentations in the second group all extending in an inclined manner relative to the visible surface at a second inclination angle (β), and
the first inclination angle (α) and the second inclination angle (β) being different from each other.

2. Panel according to claim 1, wherein the indentations in the first group are made in the panel at a substantially constant first period length, in that the indentations in the second group are made in the panel at a substantially constant second period length and in that the first period length and the second period length are different from each other.

3. Panel according to claim 2, wherein the period length of the first group of indentations and/or the period length of the second group of indentations varies between pairs of indentations.

4. Panel according to claim 1, wherein the indentations are arranged so as to overlap with one another over greater than 95%, preferably over greater than 98%, more preferably over substantially 100%, of the longitudinal extension of the respective side surface.

5. Panel according to claim 1, wherein at least one of the tools used for forming the indentations comprises at least two identically formed cutting edges.

6. Panel according claim 1, wherein the indentations in one of the groups of indentations are deeper than the indentations in the other group of indentations.

7. Panel according to claim 1, wherein in that the first group of indentations and/or the second group of indentations is formed so as to have a variable maximum depth.

8. Method for producing a panel for cladding a substrate, the panel comprising:
a visible surface, which is delimited by a plurality of side edges,
a contact surface, which extends substantially in parallel with the visible surface and is intended to contact the substrate when laid, and
a plurality of side surfaces, which extend substantially orthogonally to the visible surface and the contact surface,
in the method, a plurality of indentations, which start from the visible surface, extend so as to be inclined relative to the visible surface and end in the respective side surface, being made in the panel at the transition from the visible surface into at least one of the side surfaces to form a chamfer,
wherein the chamfer is formed solely by the plurality of indentations,
two material-removing tools being used, the cutting edges of which cut into the panel at differing inclination angles (α, β) at the transition from the visible surface into the respective side surface.

9. Method according to claim 8, wherein the panel is moved past the material-removing tools at a substantially constant feed rate, while the material-removing tools rotate at substantially constant but differing rotational speeds about their axes.

10. Method according to claim 8, wherein the panel is moved past the material-removing tools at a substantially constant feed rate, while the material-removing tools rotate at varying rotational speeds about their axes.

11. Method according to claim 8, wherein one of the material-removing tools comprises at least two cutting edges, the feed rate of the panel, the rotational speed of the material-removing tool, the relative movement direction of the material-removing tool and of the panel in their region of mutual engagement and the cutting-in depth of the cutting edges into the panel being coordinated with one another such that the indentations are arranged so as to overlap with one another over greater than 95%, preferably over greater than 98%, more preferably over substantially 100%, of the longitudinal extension of the side surface.

12. Method according to claim 8, wherein the at least one cutting edge of the tool which is assigned to the one group of indentations cuts deeper into the panel than the at least one cutting edge of the tool which is assigned to the other group of indentations.

13. Method according to claim 8, wherein the distance between the material-removing tools, which are used to produce the first group of indentations and/or the second group of indentations, and the panel is varied during processing.

14. Method according to claim 8, wherein when the indentations are being made, the panel is processed in a material-removing manner with the visible surface facing downwards.

15. Method according to claim 8, wherein after the indentations are made, the panel is printed and/or provided with a protective layer.
